(19) United States
(12) Patent Application Publication
(10) Pub. No.: US 2008/0069096 A1
(43) Pub. Date: Mar. 20, 2008

(54) METHOD AND APPARATUS FOR CONFIGURING INTERNET PROTOCOL ADDRESS, INFORMATION SERVER, AND INFORMATION STORAGE MEDIUM STORING DATA FORMAT OF MESSAGE THEREFOR

(75) Inventors: Soo-hong PARK, Gwangiu-si (KR); Han-sung Kim, Seononam-si (KR); Cheol-ju Hwang, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/740,469

(22) Filed: Apr. 26, 2007

Related U.S. Application Data
(63) Continuation of application No. 11/738,776, filed on Apr. 23, 2007.

(30) Foreign Application Priority Data
Sep. 20, 2006 (KR) 2006-91144

(51) Int. Cl. H04L 12/56

(52) U.S. Cl. 370/389

(57) ABSTRACT

A method and apparatus for configuring an (Internet protocol) IP address, an information server, and an information storage medium storing a data format of a message therefore. The method includes obtaining information on a method of configuring an IP address of a new network after a handover is performed by using an IS (information server); and configuring the IP address using the method of configuring the IP while a mobile terminal accesses the new network, thereby avoiding an unnecessary delay due to an address configuration method that is not supported in the new network, and configuring the IP address quickly and efficiently.

### CROSS-REFERENCE TO RELATED APPLICATIONS

This application is a continuation of U.S. patent application Ser. No. 11/738,776 filed Apr. 23, 2007, now pending, the disclosure of which is incorporated herein in its entirety by reference. This application also claims the benefit of Korean Patent Application No. 2006-91144, filed on Sep. 20, 2006 in the Korean Intellectual Property Office, the disclosure of which is incorporated herein by reference.

### BACKGROUND OF THE INVENTION

1. Field of the Invention

Aspects of the present invention relate to a communication system, and more particularly, to a method of configuring an IP address of a mobile terminal by using an information server.

2. Description of the Related Art

A variety of wireless environments currently need vertical handover capabilities. A vertical handover is a handover between heterogeneous networks that use different technologies. These differences in technology include different methods to configure Internet Protocol (IP) addresses. However, different IP address configuration methods cause long delays in configuring a new IP address when a handover is performed, since a mobile node may not be able to configure the IP address using the same method used by the new network.

### SUMMARY OF THE INVENTION

Aspects of the present invention provide a method and apparatus for configuring an IP address in order to minimize a delay in configuring the IP address when a handover is performed in a variety of environments, an information server, and an information storage medium storing a data format of a message for obtaining information on a method of configuring an IP address of a new network after the handover is performed using a mobile terminal.

According to an aspect of the present invention, there is provided a method of configuring an IP (Internet protocol) address comprising obtaining information from an information server (IS) about a method of configuring an IP address of a new network after a handover is performed; and configuring the IP address using the method of configuring the IP while a mobile node accesses the new network.

According to another aspect of the present invention, there is provided an apparatus for configuring an IP address comprising an IP address configuration information receiving unit to obtain information from an information server (IS) on a method of configuring an IP address of a new network after a handover is performed; and an IP address configuration performing unit to configure the IP address using the method of configuring the IP address while a mobile node accesses the new network.

According to another aspect of the present invention, there is provided a method of configuring an IP address comprising: transmitting information from an information server (IS) to a mobile node, wherein the information relates to a method of configuring an IP address of a new network after a handover is performed; and configuring the IP address using the method of configuring the IP address while the mobile node accesses the new network.

According to another aspect of the present invention, there is provided an information server (IS) to provide information on the configuration of an IP address, the IS comprising: an information transmitting unit to transmit information to a mobile node, wherein the information relates to a method of configuring the IP address of a new network after a handover is performed; wherein the mobile node configures the IP address using the method of configuring the IP address while the mobile node accesses the new network.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an apparatus for configuring an IP address according to an embodiment of the present invention;

FIG. 2 is a flowchart of a method of configuring an IP address according to an embodiment of the present invention;

FIG. 3 illustrates a mobile communication environment where a method of configuring an IP address is performed according to an embodiment of the present invention;

FIG. 4 illustrates network layers used to configure an IP address according to an embodiment of the present invention; and

FIGS. 5, 6, and 7 illustrate a data format of a message used in a method and apparatus for configuring an IP address according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

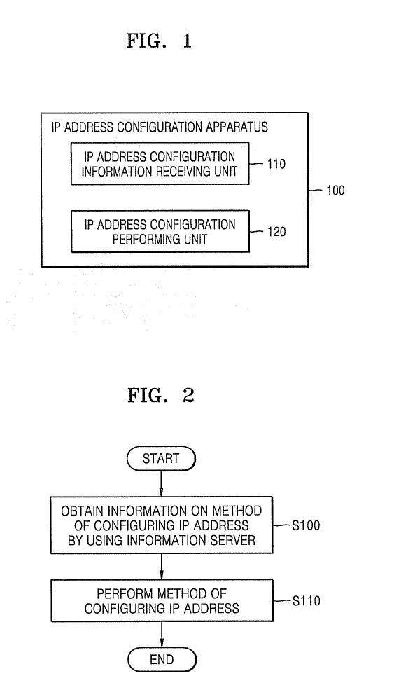

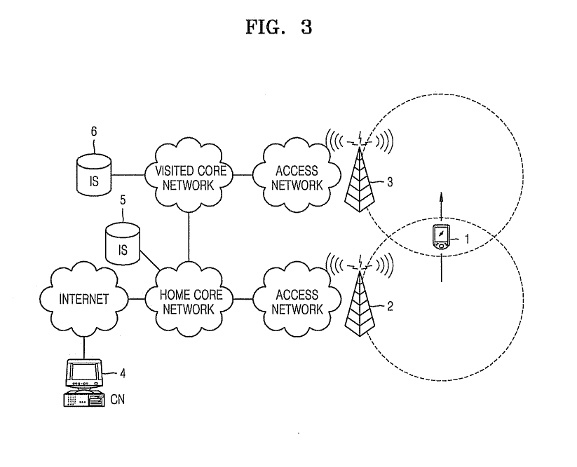

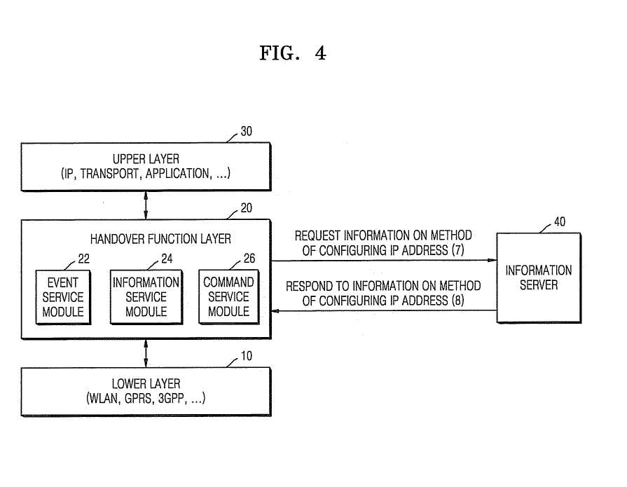

FIG. 1 is a block diagram of an apparatus 100 to configure an IP address according to an embodiment of the present invention. FIG. 2 is a flowchart of a technique of configuring an IP address according to an embodiment of the present invention. Referring to FIG. 1, the apparatus 100 to configure the IP address comprises an IP address configuration information receiving unit 110 and an IP address configuration performing unit 120. The apparatus 100 may a component of a mobile node, such as mobile node MN 1 shown in FIG. 3. The technique of configuring the IP address according to aspects of the invention will now be described with reference to FIGS. 1 and 2.

The IP address configuration information receiving unit 110 obtains information on the method of configuring the IP address of a new network after a handover is performed by using an information server IS (Operation 100). The IP address configuration performing unit 120 configures the IP address using the method of configuring the IP address while a mobile node, such as the mobile node MN 1 shown in FIG. 3, accesses the new network (Operation 110).

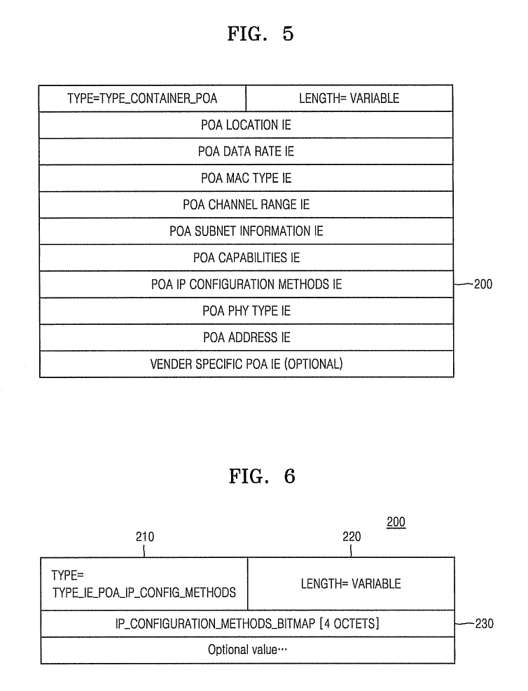

For an understanding of the operation of an embodiment of the invention, an environment where the method of configuring the IP address is performed will now be described with reference to FIGS. 3 and 4. FIG. 3 illustrates a mobile communication environment where the technique of configuring the IP address is performed according to an embodiment of the present invention. The mobile communication environment comprises a mobile node MN 1, points of attachment PoAs 2 and 3, a correspondent node CN 4, information servers ISs 5 and 6, and a plurality of networks. It will be understood by those of ordinary skill in the art that a variety of other topologies, including various devices, are possible in addition to the network topology illustrated in FIG. 3.

The MN 1 uses the mobile communication environment. When the MN 1 begins mobile communication, the MN 1 registers a home address (HoA) in a home agent over a home network. When the MN 1 moves to another network, the MN 1 obtains a care of address (CoA) from a foreign agent (FA) that is an agent of the other network. The MN 1 sends the CoA to the home agent to register the CoA. The home agent associates the CoA with the HoA using a process called address binding. When the MN 1 moves to a new network and obtains a new CoA for the new network, the MN 1 sends the new CoA to the home agent. The home agent cancels the previous address binding and performs a binding update BU, a new binding of the HoA and the new CoA.

The CN 4 should know an address of the MN 1 in order to transmit data to the MN 1. Since the CN 4 knows the HoA, the CN 4 sets the HoA as a receiving address and transmits the data to the home agent. The home agent determines the CoA corresponding to the HoA, sets the CoA as the receiving address, and transmits the data to the MN 1 over the networks.

The PoAs 2 and 3 connect the MN 1 to the networks. Examples of PoAs 2 and 3 are an access point (AP) and a base station (BS). However, according to other aspects of the invention, the PoAs 2 and 3 may be other devices permitting access to a network. The PoAs 2 and 3 can perform data transmission between the MN 1 and networks.

A handover is performed when the MN 1 moves to another network. Referring to FIG. 3, a handover occurs when the MN 1 moves from a network area where data communication is performed through the current PoA 2 to a new network area where data communication is performed through the PoA 3.

The MN 1 receives information about the new network and the PoA 3 of the new network via the current PoA 2. The information may come from ISs 5 and 6, though according to other aspects of the invention the information may come from another component of the network. For example, when the current PoA 2 serves as an IS, the MN 1 can receive the information on the new network and the PoA 3. The MN1 determines a network protocol used in the new network, a service supported by the new network, etc. using the received information, in order to prepare for the network protocol, the service, etc.

It is important to configure a CoA to be used by the MN 1 in the new network during the handover. The technique of configuring the IP address according to an embodiment of the present invention obtains information on how to configure the IP address in the new network from the ISs 5 and 6 in advance and configures the IP address based on the information received.

Since the information on how to configure the IP address in the new network might not be obtained without the technique according to aspects of the present invention, it is useful to determine the PoA 3 of the new network and how the new network configures IP addresses. For example, the MN 1 receives a router advertisement RA message from the PoA 3 and attempts to extract an Internet protocol version 6 (IPv6) prefix from the RA message. However, if the new network does not support IPv6 prefixes, the MN 1 needs to configure the IP address by using another IP address configuration method, e.g., a dynamic host configuration protocol (DHCP). In this case, delays occur due to the communication of unnecessary messages.

FIG. 4 illustrates network layers used to configure an IP address according to an embodiment of the present invention. The network layers of a mobile node comprise a lower layer 10, a handover function layer 20, and an upper layer 30. The lower layer 10 includes a second layer and layers lower than the second layer among the seven layers defined by the open systems interconnection (OSI) reference model, i.e., the link layer, the physical layer, etc. The lower layer 10 can support a variety of network standards. For example, the lower layer 10 can support one or more wireless local area networks (WLANs), general packet radio services (GPRSs), a 3^{rd} generation partnership project (3GPP), etc. The upper layer 30 includes a third layer and layers higher than the third layer among the seven layers defined by the OSI reference model, i.e., the IP layer, a mobile IP layer, the transport layer, the application layer, etc.

The handover function layer 20 supports a handover performed between the lower layer 10 and the upper layer 30. The handover function layer 20 is not defined by the OSI reference model. Rather, the handover function layer 20 is a 2.5 layer between the lower layer 10 and the upper layer 30. The handover function layer 20 independently supports a handover between heterogeneous links having a media type of link accessed by the MN 1. The handover function layer 20 independently supports handovers between heterogeneous links having a type of link interface supported by the lower layer 10.

The handover function layer 20 includes an event service module 22, an information service module 24, and a command service module 26. The event service module 22 detects the occurrence of an event related to a handover between various links in the MN 1 and reports the occurrence of the event to the upper layer 30. The event service module 22 requests the MN 1 to register the CN 4 so that the CN 4 can receive notice of the event and receives a message indicating the occurrence of the event from the MN 1 in which the CN 4 is registered. The information service module 24 obtains information on the handover between heterogeneous links performed by the MN 1 from the ISs 5 and 6 that collect information on the handover between heterogeneous links performed by the MN 1 or from a PoA that serves as an IS. The command service module 26 controls a handover performed in the lower layer 10, i.e., in the link layer, according to commands input from the upper layer 30. These commands may include, for example, commands input by a user.

The method and apparatus for configuring the IP address according to aspects of the present invention may be related to the information service module 24. The information service module 24 receives information on a new network in the form of an information element (IE) and determines the environment of the new network using the information on the new network.

The IP address configuration information receiving unit 110 illustrated in FIG. 1 may be included in the information service module 24. However, the present invention is not limited thereto. According to other aspects of the invention, the IP address configuration information receiving unit 110 can be excluded from the information service module 24 or included in another module.

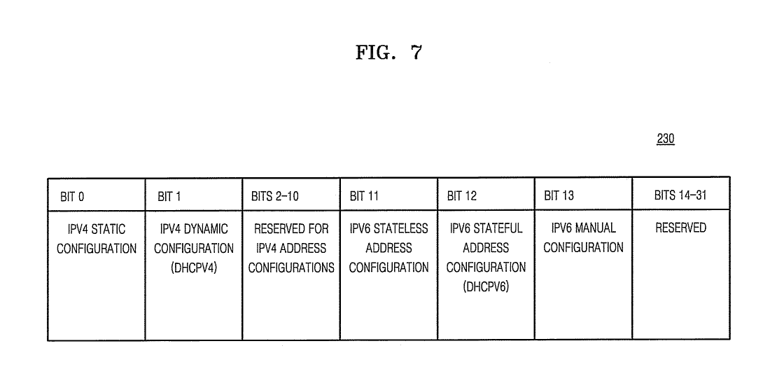

If the MN 1 moves to the new network, the MN 1 requests the ISs 5 and 6 to provide information on the new network. The ISs 5 and 6 transmit the information on the new network in the form of the IE. FIGS. 5, 6, and 7 illustrate a data format of a message used in a method and apparatus for configuring an IP address according to an embodiment of the present invention.

FIG. 5 illustrates an IE that the information service module 24 and the ISs 5 and 6 communicate between each other. The ISs 5 and 6 transmit a variety of IEs. The PoA configuration methods IE may include information on a method of configuring a PoA IP address.

FIG. 6 illustrates the PoA IP configuration methods IE 200. The PoA IP configuration methods IE 200 includes a type field 210 indicating that the IE is about the PoA IP configuration methods IE 200, a field 220 indicating the length of the IE, and a field 230 indicating the information on the method of configuring an IP address of the new network. The information on the method of configuring the IP address of the new network may be expressed in the form of bitmap, although other aspects of the invention may use other forms.

FIG. 7 illustrates information on the method of configuring the IP address of the new network expressed in the form of a bitmap. Examples of methods of configuring the IP address of the new network include an IPv4 static configuration method, an IPv4 dynamic configuration method, an IPv6 address autonomous configuration method (an IPv6 stateless address configuration method), a dynamic host configuration protocol version 6 (DHCPv6) configuration method (an IPv6 stateful address configuration method), an IPv6 manual configuration method, etc. Networks according to other aspects of the invention may use other methods.

Bits 0, 1, 11, 12, and 13 are designated for each of the configuration methods. The designation of other bits can be reserved to indicate a different IPv4 address configuration method or a different IPv6 address configuration method. Some of the address configuration methods illustrated in FIG. 7, e.g., the IPv6 address autonomous configuration method and the DHCPv6 configuration method, can correspond to bits 11 and 12, respectively. The order in which the bits are designated to the address configuration methods illustrated in FIG. 7 can be changed.

The MN 1 and the ISs 5 and 6 know the types of address configuration methods to be included in the PoA IP configuration methods IE 200 and the order in which the bits are designated. The bit designated to the method of configuring the IP address of the new network has a value 1, and the bit designated to the other address configuration methods has a value 0. The address configuration methods may be expressed in the form of a bitmap to reduce the amount of data to be transferred, thereby reducing network traffic.

An operation of configuring an address using the method of configuring the IP address of the new network transferred from the ISs 5 and 6 while accessing the new network will now be described in detail. When the MN 1 expects to use the IPv6 address autonomous configuration method in the new network, it configures the IP address, giving priority to using the IPv6 address autonomous configuration method. The ISs 5 and 6 are accurately informed of information on an address configuration method used in the new network. Therefore, an unnecessary delay caused by an attempt to use another address configuration method can be avoided.

Even if an address configuration method supported in the new network changes, when the change in the address configuration method is updated in the ISs 5 and 6, or the address configuration method supported in the new network is not, for some reason, used any more, the new address configuration method supported in the new network may be inconsistent with information obtained from the ISs 5 and 6. In this case, when the address is configured based on the information obtained from the ISs 5 and 6, delays can occur. However, since the address configuration method supported in the new network is almost always consistent with information obtained from the ISs 5 and 6, these delays are rare and minor.

When the IP address configuration method of the new network is the IPv6 address autonomous configuration method, the bit 11 has a value 1 and the other bits have a value 0. The IP address configuration performing unit 120 performs an address autonomous configuration operation. While the MN 1 accesses the new network, the IP address configuration performing unit 120 transmits a router solicitation (RS) message to a router of the new network. The RS message requests the router to provide a router advertisement (RA) message. The RA message includes the IPv6 prefix. The IP address configuration performing unit 120 receives the RA message from the router and generates an IPv6 address using the IPv6 prefix included in the RA message.

When the DHCPv6 configuration method is used in the new network, the IP address configuration performing unit 120 requests an IPv6 address from a DHCP server using, for example, a DHCPDISCOVER message, while the MN 1 accesses the new network. The DHCP server transmits the IPv6 address using, e.g., a DHCPOFFER message or a DHCPACK message. The IP address configuration performing unit 120 receives the IPv6 address from the DHCP server and sets the IPv6 address as an IPv6 address of the new network.

When the IPv4 static configuration method, the IPv4 dynamic configuration method or the IPv6 manual configuration method is used in the new network, it is performed in a similar manner as the techniques described above, and therefore will be understood by those of ordinary skill in the art. A detailed description thereof is therefore omitted.

If the MN 1 uses the IP address configuration method according to aspects of the present invention, the MN 1 can quickly determine a network to use based on the information on the IP address configuration method of the new network transferred from the ISs 5 and 6. The MN 1 can access several network areas, even if the MN 1 is in the same physical area. For example, the MN 1 can access a network A that uses the IPv6 address autonomous configuration method and a network B that uses the DHCPv6 configuration method.

When an MN that does not use the IP address configuration method according to the present embodiment supports the DHCPv6 configuration method, if the MN attempts to access the network A first, the MN fails to access the network A and reattempts to access the network B. This process causes unnecessary delays.

If the MN 1 uses the IP address configuration method according to aspects of the invention, the MN 1 receives information on methods of configuring IP addresses of the networks A and B from the ISs 5 and 6, and determines which network to access first. For example, when the MN 1 supports the DHCPv6 configuration method, the MN 1 does not attempt to access the network A. Instead, the mobile node MN 1 accesses the network B directly.

The technique to configure an IP address according to aspects of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, etc., including a carrier wave transmitting signals specifying the program instructions, data structures, etc. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention.

According to aspects of the present invention, information on an IP address configuration method used in a new network is obtained from an information server in advance in order to configure the IP address, thereby avoiding an unnecessary delay due to an address configuration method that is not supported in the new network, and configuring the IP address quickly and efficiently. IP address configuration information used in adjacent networks is obtained in advance, thereby determining a network to be accessed in advance from among the accessible networks.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A method of configuring an IP address comprising:
transmitting information from an information server (IS) to a mobile node, wherein the information relates to a method of configuring an IP address of a new network after a handover is performed; and
configuring the IP address of the mobile node using the method of configuring the IP address while the mobile node accesses the new network.

2. The method according to claim 1, wherein the information on the method of configuring the IP address of the new network comprises:
information on whether the new network uses an IPv6 stateless address configuration method using an IPv6 address autonomous configuration; and
information on whether the new network uses an IPv6 stateful address configuration method using a DHCPv6 configuration.

3. The method according to claim 2, wherein the information on the method of configuring the IP address of the new network further comprises:
information on whether the new network uses an IPv4 static configuration method;
information on whether the new network uses an IPv4 dynamic configuration method; and
information on whether the new network uses an IPv6 manual configuration method.

4. The method of claim 1, wherein the information on the method of configuring the IP address of the new network is an information element (IE) including information on the new network after the handover is performed.

5. The method according to claim 4, wherein the information on the method of configuring the IP address of the new network is transferred in the form of a point of attachment (PoA) IP configuration methods IE.

6. An information server (IS) to provide information on the configuration of an IP address, the IS comprising:
an information transmitting unit to transmit information to a mobile node, wherein the information relates to a method of configuring the IP address of a new network after a handover is performed,
wherein the mobile node configures the IP address using the method of configuring the IP address while the mobile node accesses the new network.

7. The IS according to claim 6, wherein the information on the method of configuring the IP address of the new network comprises:
information on whether the new network uses an IPv6 stateless address configuration method using IPv6 address autonomous configuration; and
information on whether the new network uses an IPv6 stateful address configuration method using DHCPv6 configuration.

8. The IS according to claim 7, wherein the information on the method of configuring the IP address of the new network further comprises:
information on whether the new network uses an IPv4 static configuration method;
information on whether the new network uses an IPv4 dynamic configuration method; and
information on whether the new network uses an IPv6 manual configuration method.

9. An information storage medium storing a data format of a message to obtain information on a method of configuring an IP address of a new network after a handover is performed in a mobile node using an information server (IS), the information storage medium comprising:
a field including information on whether the new network uses an IPv6 stateless address configuration method using an IPv6 address autonomous configuration; and
a field including information on whether the new network uses an IPv6 stateful address configuration method using a DHCPv6 configuration.

10. The information storage medium according to claim 9, further comprising:
a field including information on whether the new network uses an IPv4 static configuration method;
a field including information on whether the new network uses an IPv4 dynamic configuration method; and
a field including information on whether the new network uses an IPv6 manual configuration method.

11. The information storage medium according to claim 9, wherein the fields including the information on the method of configuring the IP address of the new network include a data format in the form of a bitmap in which a bit corresponding to the method used to configure the IP address of the new network has a value 1, and bits corresponding to other methods of configuring the IP address have a value 0.

12. A network comprising:
an information server to store information about a method to configure an IP address of a mobile node in the network and to transmit the information to a mobile node; and
a mobile node to receive the information and to configure an IP address based on the method to configure an IP address.
